(19) United States
(12) Patent Application Publication
(10) Pub. No.: US 2002/0054007 A1
(43) Pub. Date: May 9, 2002

(54) Process for producing liquid crystal device and driving method of the device

(76) Inventors: Yasufumi Asao, Atsugi-shi (JP); Hirohide Munakata, Yokohama-shi (JP); Takeshi Togano, Chigasaki-shi (JP); Hideo Mori, Yokohama-shi (JP); Koji Noguchi, Sagamihara-shi (JP); Ryuichiro Isobe, Atsugi-shi (JP)

Correspondence Address: FITZPATRICK CELLA HARPER & SCINTO, 30 ROCKEFELLER PLAZA, NEW YORK, NY, 10112, US

(21) Appl. No.: 09/915,468

(22) Filed: Jul. 27, 2001

(30) Foreign Application Priority Data
Jul. 31, 2000 (JP) 232383/2000

(51) Int. Cl. G09G 3/36

(52) U.S. Cl. 345/92

(57) ABSTRACT

An active matrix-type liquid crystal device including: a pair of substrates, a chiral smectic liquid crystal disposed between the substrates so as to form a matrix of pixels arranged in a plurality of rows and a plurality of columns, a plurality of active elements each provided to a pixel for supplying a voltage applied to the liquid crystal at the pixel, and an electrode matrix including drive signal supply electrodes for applying drive signal voltages to the respective active elements which will be turned on by periodically applying the data signal voltages to associated pixels in a succession of display frame periods is produced by a the process characterized by the step of: periodically turning on the active elements by periodically applying conditioning voltages to associated pixels in a succession of conditioning periods, preceding the display frame periods, in which the periodically applied conditioning voltages have an identical polarity over at least two consecutive conditioning periods, thereby to stabilize a voltage-transmittance of the liquid crystal.

### FIELD OF THE INVENTION AND RELATED ART

The present invention relates to a process for producing a liquid crystal device using a liquid crystal for effecting various displays, and a driving method of the liquid crystal device.

As a type of a nematic liquid crystal display device used heretofore, there has been known an active matrix-type liquid crystal device wherein each pixel is provided with an active element (e.g., a thin film transistor (TFT)).

As a nematic liquid crystal material used for such an active matrix-type liquid crystal device using a TFT, there has been presently widely used a twisted nematic (TN) liquid crystal as disclosed by M. Schadt and W. Helfrich, “Applied Physics Letters”, Vol. 18, No. 4 (Feb. 17, 1971), pp. 127-128.

In recent years, there has been proposed a liquid crystal device of In-Plane Switching mode utilizing an electric field applied in a longitudinal direction of the device or of Vertical Alignment mode, thus improving a viewing angle characteristic being poor in the conventional liquid crystal displays.

As described above, there are various liquid crystal modes suitable for the TFT-type liquid crystal device using the nematic liquid crystal material. In any mode however, the resultant nematic liquid crystal display device has encountered a problem of a slow response speed of several ten milliseconds or above.

In order to improve the response characteristic of the conventional types of nematic liquid crystal devices, several liquid crystal devices using a specific chiral smectic liquid crystal, such as a ferroelectric liquid crystal of a short pitch-type, a polymer-stabilized ferroelectric liquid crystal or an anti-ferroelectric liquid crystal showing no threshold (voltage) value have been proposed. Although, these devices have not been put into practical use sufficiently, it has been reported that a high-speed responsiveness on the order of below millisecond is realized.

With respect to the chiral smectic liquid crystal device, our research group has proposed a liquid crystal device as in U.S. patent application Ser. No. 09/338426 (filed Jun. 23, 1999) (corr. to Japanese Laid-Open Patent Application (JP-A) 2000-338464) wherein a chiral smectic liquid crystal has a phase transition series on temperature decrease of isotropic liquid phase (Iso)−cholesteric phase (Ch) −chiral smectic C phase (SmC*) or Iso−SmC* and liquid crystal molecules are monostabilized at a position inside an edge of or at a virtual cone. During the phase transition of Ch−SmC* or Iso−SmC*, liquid crystal molecular layers are uniformly oriented or aligned in one direction, e.g., by applying a DC voltage of one polarity (+or −) between a pair of substrates to improve high-speed responsiveness and gradation control performance and realize a high-luminance liquid crystal device excellent in motion picture image qualities with a high mass-productivity. The liquid crystal device of this type may advantageously be used in combination with active elements because the liquid crystal material used has a relatively small spontaneous polarization compared with those used in the conventional chiral smectic liquid crystal devices.

In the above-mentioned liquid crystal devices (panels), however, a desired gradational display level is less liable to be attained in some cases. More specifically, even when electrical driving conditions are set so as to provide a desired gradational display level, a resultant visually recognized display image can be liable to has a gradational level which is not coincident with the desired gradational display level.

In order to solve the problem, our research group has proposed a voltage application treatment (hereinafter, referred to as “aging or conditioning treatment”) to the liquid crystal device as described in Japanese Patent Application No. 2000-106381 (filed Apr. 7, 2000). More specifically, a relationship between an applied voltage and a transmittance (i.e., a voltage-transmittance (V-T) characteristic) of a chiral smectic liquid crystal is not stabilized immediately after production of the liquid crystal device (panel) using the liquid crystal in some cases. In such cases, when the liquid crystal device is driven without effecting a treatment, the liquid crystal used is placed in a stable state by a driving voltage applied thereto, thus being liable to result in image memory (burning or sticking). For this reason, with respect to a liquid crystal panel exhibiting such an unstable V-T characteristic immediately after production, an aging treatment has been effected before the liquid crystal panel is driven for ordinary image display, thus intentionally placing the liquid crystal having the unstable V-T characteristic in a stable state (providing a stable V-T characteristic) so as not to cause a change in V-T characteristic at the time of image display operation. However, such an aging treatment has been performed by changing the applied voltage alternately for each time of turning on the active elements (e.g., at (c) of FIG. 4). The applied voltage is then lowered due to inversion of liquid crystal molecules by a certain voltage (Vd at (c) of FIG. 4), thus reducing the effect of aging treatment by that much. As a result, the aging treatment takes a longer time.

### SUMMARY OF THE INVENTION

A principal object of the present invention is to provide a chiral smectic liquid crystal device using a plurality of active elements having solved the above-mentioned problem.

A specific object of the present invention is to provide a process for producing an active matrix-type chiral smectic liquid crystal device capable of allowing an aging treatment in a short period of time so as to prevent an occurrence of image burning.

Another object of the present invention is to provide a driving method for an active matrix-type chiral smectic liquid crystal device capable of allowing an aging treatment in a short period of time so as to prevent an occurrence of image burning.

According to the present invention, there is provided a process for producing a liquid crystal device of the type comprising: a pair of substrates, a chiral smectic liquid crystal disposed between the substrates so as to form a matrix of pixels arranged in a plurality of rows and a plurality of columns, a plurality of active elements each provided to a pixel for supplying a voltage applied to the liquid crystal at the pixel, and an electrode matrix including drive signal supply electrodes for applying drive signal voltages to the respective active elements which will be turned on by periodically applying the data signal voltages to associated pixels in a succession of display frame periods;

the process, comprising the steps of:

periodically turning on the active elements by periodically applying conditioning voltages to associated pixels in a succession of conditioning periods, preceding the display frame periods, in which the periodically applied conditioning voltages have an identical polarity over at least two consecutive conditioning periods, so as to stabilize a voltage-transmittance of the liquid crystal.

According to the present invention, there is also provided a driving method for a liquid crystal device of the type comprising: a pair of substrates, a chiral smectic liquid crystal disposed between the substrates so as to form a matrix of pixels arranged in a plurality of rows and a plurality of columns, a plurality of active elements each provided to a pixel for supplying a voltage applied to the liquid crystal at the pixel, and an electrode matrix including drive signal supply electrodes for applying drive signal voltages to the respective active elements;

the driving method, comprising the steps of:

periodically turning on by periodically applying the data signal voltages to associated pixels in a succession of display frame periods; and

periodically turning on the active elements by periodically applying conditioning voltages to associated pixels in a succession of conditioning periods, preceding the display frame periods, in which the periodically applied conditioning voltages have an identical polarity over at least two consecutive conditioning periods, so as to stabilize a voltage-transmittance of the liquid crystal.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an embodiment of the active matrix-type liquid crystal device used in the present invention.

FIG. 2 is a schematic plan view of an active matrix substrate of the liquid crystal device used in the present invention connected with drive means (circuits).

FIG. 3 is an equivalent circuit of the liquid crystal device used in the present invention.

FIG. 4 is a time chart of driving waveforms for the liquid crystal device shown in FIGS. 1-3.

FIG. 5 is a graph showing a voltage-transmittance (V-T) characteristic of a chiral smectic liquid crystal used in the present invention.

FIG. 6 is a graph showing a relationship between an aging period and a transmittance.

FIG. 7 is a time chart of aging voltage waveforms for the liquid crystal device shown in FIGS. 1-3 employed in the present invention.

FIG. 8 is a time chart of aging voltage waveforms for the liquid crystal device shown in FIGS. 1-3.

### DESCRIPTION OF THE PREFERRED EMBODIMENTS

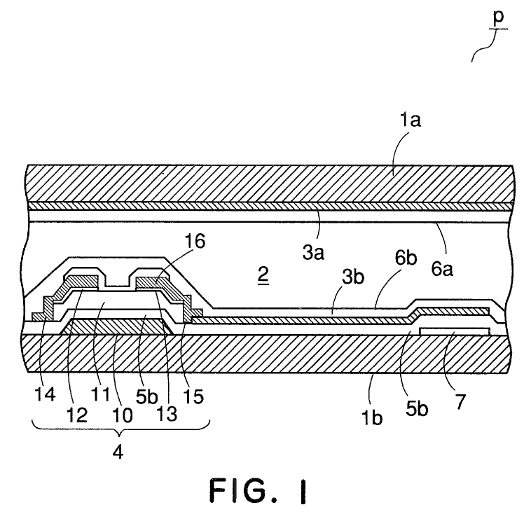

Hereinbelow, the present invention will be described more specifically, with reference to FIGS. 1-5.

A cell structure of active matrix-type liquid crystal device produced by the production process of the present invention will be explained with reference to FIG. 1.

FIG. 1 shows one-pixel portion of an active matrix-type liquid crystal device (panel) P.

Referring to FIG. 1, the liquid crystal device P includes a pair of substrates 1a and 1b. On the substrate 1a, an electrode 3a and an alignment control film 6a are successively disposed. On the substrate 1b, a thin film transistor (TFT) as an active element 4 (described later in detail) including an extended insulating film 5b and a storage (holding) capacitor electrode 7 are disposed. On the insulating film 5b, an electrode 3b and an alignment control film 6b are successively disposed. The pair of substrates 1a and 1b are disposed with a prescribed cell gap into which a chiral smectic liquid crystal 2 is filled.

In the production process of the present invention, the chiral smectic liquid crystal 2 is supplied with an aging (or conditioning) voltage via the pair of electrodes 3a and 3b to stabilize a V-T characteristic of the liquid crystal 2. Herein, the “aging or conditioning voltage” refers to a voltage applied to the liquid crystal 2 in order to stabilize a V-T characteristic of the liquid crystal 2 and such a voltage application treatment is referred to as “aging treatment”.

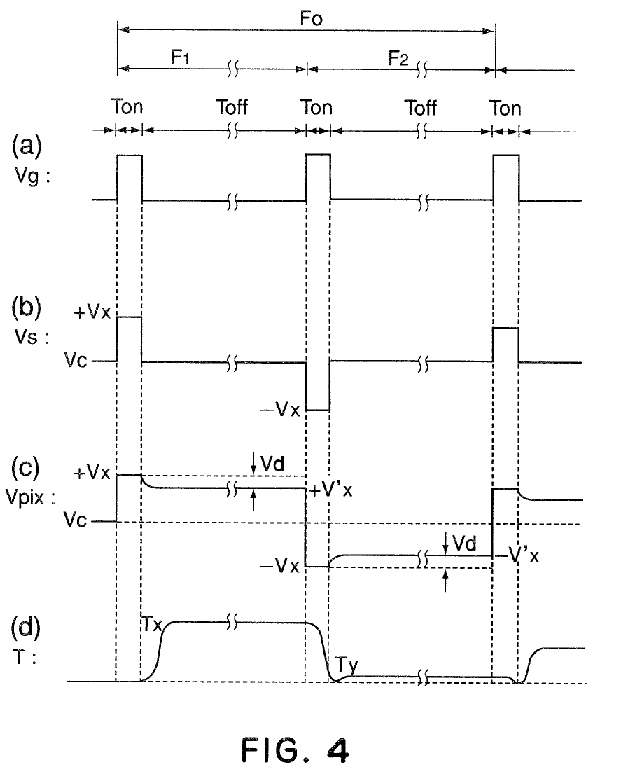

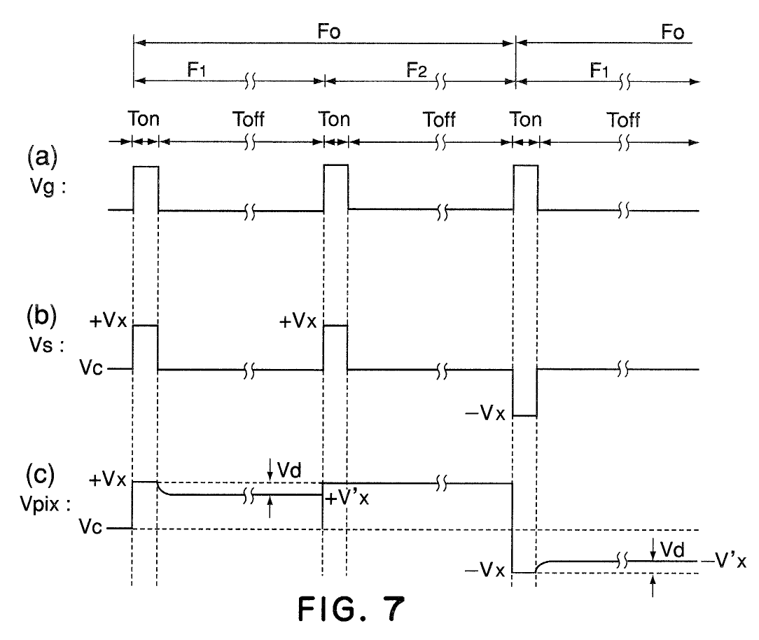

In the aging treatment employed in the present invention, the polarity of the aging or conditioning voltage is identical over at least two consecutive field periods (conditioning period) in each frame period or over consecutive frame periods (e.g., +Vx in F1 and +Vx in F2 as shown at (c) in FIG. 7) different from the case where the positive-polarity voltage (+Vx) and the negative-polarity voltage (−Vx) are alternately applied for each on-time of the active elements as shown at (c) of FIG. 4.

The application of aging (conditioning) voltage may, e.g., be effected by applying a prescribed-polarity voltage (potential) in at least two consecutive periods (e.g., (+)→(+), (−)→(−) or 0 (V)−0 (V)) to one of the pair of electrodes 3a and 3b and applying another prescribed-polarity voltage (potential) in the above-mentioned at least two consecutive periods to the other electrode.

Herein, “identical” with respect to the polarity does not mean that the polarity of a voltage (potential) applied to one electrode 3a is identical to that of a voltage (potential) applied to the other electrode 3b but means that a polarity of aging or conditioning voltage applied to the liquid crystal was not changed over consecutive field periods.

In a preferred embodiment, the aging voltage is applied in such a manner that a voltage of one polarity is periodically applied over at least two consecutive periods and a voltage of another polarity is applied in at least one period subsequent to the consecutive periods.

The aging voltage determined by voltages (potentials) applied to the pair of electrodes 3a and 3b is applied to the chiral smectic liquid crystal 2 as it is, thus stabilizing a resultant V-T characteristic of the liquid crystal 2. These electrodes 3a and 3b constitute a liquid crystal capacitance (specifically described hereinafter) in combination with the liquid crystal 2, so that the aging voltage is continuously applied to the liquid crystal 2 in a (non-selection) period wherein the active elements 4 are placed in “OFF” state.

The aging treatment (application of the aging voltage) may preferably be performed when the liquid crystal 2 is placed in a chiral smectic C phase (SmC*). Specifically, the aging voltage may preferably be applied to the liquid crystal 2 after the liquid crystal 2 is once heated to an isotropic (liquid) phase (Iso.) temperature or a cholesteric phase (Ch) temperature and is then cooled to SmC* temperature.

The aging treatment may preferably be performed to all the pixels of the liquid crystal device.

Further, the aging voltage may desirably be set to be a value as large as possible within a withstand voltage of the active elements 4 or driver ICs.

The V-T characteristic of the liquid crystal 2 once placed in a stable state by the above-mentioned aging treatment is not readily returned to the (original) unstable state, so that the aging treatment may be sufficient to stabilize the V-T characteristic if it is performed only one time. However, as an exceptional case (e.g., where an environmental temperature of the liquid crystal device P is changed abruptly), the V-T characteristic can be returned to the unstable state. In this case, the aging treatment may be performed again.

Next, the driving method for an active matrix-type liquid crystal device according to the present invention will be described.

The above-mentioned aging treatment effected during the production process thereof (before a product of the liquid crystal device is shipped from its factory) may be performed to the liquid crystal device after the shipping. Alternatively, the aging treatment may be performed before and after the shipping of the liquid crystal device.

The aging treatment to be effected after the shipping may be performed in the driving method for the liquid crystal device in a similar manner and under similar conditions as in the above-mentioned production process of the liquid crystal device according to the present invention.

The aging treatment in the driving method for the liquid crystal device of the present invention may be performed automatically in such a manner that the aging treatment is incorporated in a drive sequence of the liquid crystal device in advance and is performed after the power is turned on by a user (at the time of start-up state of a liquid crystal apparatus) or performed at the time of actuating a screen saver (program). In these cases, if the liquid crystal apparatus includes an illumination device (such as a backlight device or a front light device), the aging treatment may preferably be performed in such a state that the liquid crystal device is not illuminated with light (i.e., in a state that the illumination device is in a non-lighting state). As a result, it is possible to prevent switching or drive of the liquid crystal from being recognized as an image, thus obviating an erroneous recognition such that the user misunderstands the liquid crystal apparatus being in a malfunction state.

Then, respective constitutional members of the liquid crystal device P will be described more specifically.

The chiral smectic liquid crystal 2 used in the present invention may preferably have a phase transition series on temperature decrease of isotropic liquid phase (Iso)−cholesteric phase (Ch)−chiral smectic C phase (SmC*) or Iso−SmC*.

The chiral smectic liquid crystal 2 may preferably be used in such a state in SmC* that liquid crystal molecules are monostabilized at a position inside an edge of or at an edge position of a virtual cone under no electric field application.

The chiral smectic liquid crystal 2 may preferably be a liquid crystal composition prepared by appropriately blending a plurality of liquid crystal materials, e.g., selected from hydrocarbon-type liquid crystal materials containing a biphenyl, phenyl-cyclohexane ester or phenyl-pyrimidine skeleton; naphthalene-type liquid crystal materials; and fluorine-containing liquid crystal materials.

The liquid crystal composition as the chiral smectic liquid crystal used in the liquid crystal device may preferably comprise at least two compounds each represented by the following formulas (1), (2), (3) and (4).

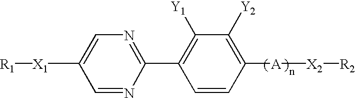

wherein A is

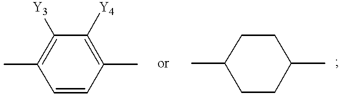

R1 and R2 are independently a linear or branched alkyl group having 1-20 carbon atoms optionally having a substituent; X1 and X2 are independently a single bond O, COO or OOC; Y1, Y2, Y3 and Y4 are independently H or F; and n is 0 or 1.

Formula (2)

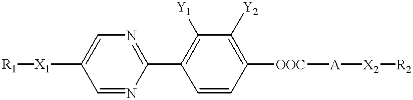

wherein A is

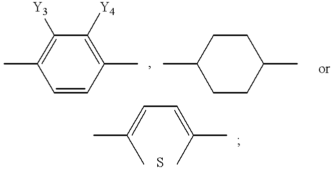

R1 and R2 are independently a linear or branched alkyl group having 1-20 carbon atoms optionally having a substituent; X1 and X2 are independently a single bond O, COO or OOC; and Y1, Y2, Y3 and Y4 are independently H or F.

Formula (3)

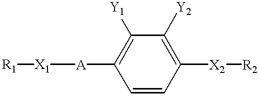

wherein A:

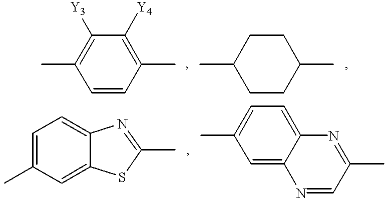

or

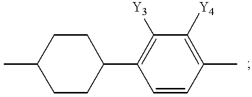

R1 and R2 are independently a linear or branched alkyl group having 1-20 carbon atoms optionally having a substituent X1 and X2 are independently a single bond O, COO or OOC; and Y1, Y2, Y3 and Y4 are independently H or F.

Formula (4)

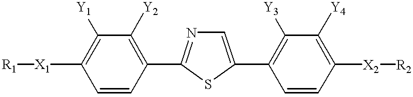

wherein R1 and R2 are independently a linear or branched alkyl group having 1-20 carbon atoms optionally having a substituent; X1 and X2 are independently a single bond, O, COO or OOC; and Y1, Y2, Y3 and Y4 are independently H or F.

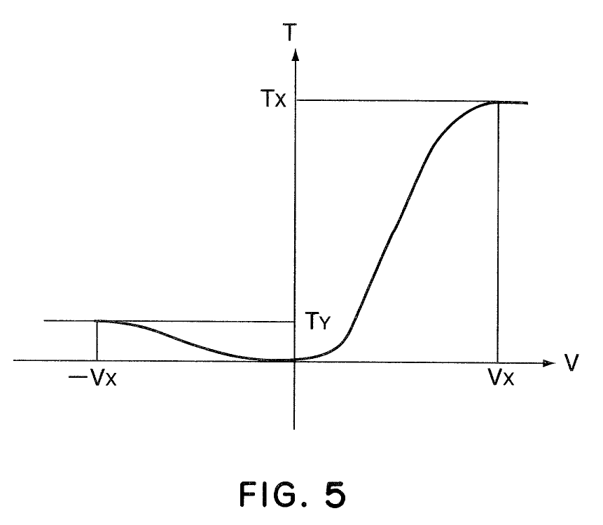

The liquid crystal device having the above-mentioned liquid crystal cell structure can be prepared by using the chiral smectic liquid crystal (liquid crystal material) 2 while adjusting the composition thereof, and further by appropriate adjustment of the liquid crystal material treatment, the device structure including a material, and a treatment condition for alignment control films 6a and 6b. As a result, in a preferred embodiment of the present invention, the liquid crystal material may preferably be placed in an alignment state such that the liquid crystal molecules are aligned to provide an average molecular axis to be mono-stabilized in the absence of an electric field applied thereto and, under application of voltages of one polarity (a first polarity), are tilted in one direction from the average molecular axis under no electric field to provide a tilting angle which varies continuously from the average molecular axis of the monostabilized position depending on the magnitude of the applied voltage. On the other hand, under application of voltages of the other polarity (i.e., a second polarity opposite to the first polarity), the liquid crystal molecules are tilted in the other direction from the average molecular axis under no electric field depending on the magnitude of the applied voltages. Specifically, the liquid crystal 2 has a V-T characteristic, e.g., shown in FIG. 5, i.e., lacks its memory characteristic (bistability) intrinsic to the chiral smectic liquid crystal, so that the magnitude of tilting angle can be controlled continuously by the applied voltage and correspondingly, a (transmitted) light quantity of the liquid crystal device can also be changed continuously, thus allowing a halftone (gradation) display. Further, in this embodiment a maximum tilting angle β1 obtained under application of the first polarity voltages based on the monostabilized position is substantially larger than a maximum tilting angle β2 formed under application of the second polarity voltages, i.e., β1>β2. Further, β2 may be substantially zero deg., i.e., the average molecular axis is not moved substantially under application of the second polarity voltages.

In the liquid crystal device P shown in FIG. 1, each of the substrates 1a and 1b comprises a transparent material, such as glass or plastics, and is coated with, e.g., a plurality of electrodes 3a (3b) of In₂O₃ or ITO (indium tin oxide) for applying a voltage to the liquid crystal 2. These electrodes 3b and 3b are arranged, e.g., in a (dot-)matrix form. In a preferred embodiment, as described later, one of the substrates 1a and 1b is provided with a matrix electrode structure wherein dot-shaped transparent electrodes are disposed as pixel electrodes in a matrix form and each of the pixel electrodes is connected to a switching or active element, such as a TFT (thin film transistor) or MIM (metal-insulator-metal), and the other substrate may be provided with a counter (common) electrode on its entire surface or in an prescribed pattern, thus constituting an active matrix-type liquid crystal device.

On the electrodes 3a and 3b, the insulating films 83a and 83b, e.g., of SiO₂, TiO₂ or Ta₂O₅ having a function of preventing an occurrence of short circuit may be disposed, respectively, as desired. In FIG. 1, only the insulating film 5b covering the electrode 3b is shown.

In the liquid crystal device P, the alignment control films 6a and 6b are disposed so as to control the alignment state of the liquid crystal 15 contacting the alignment control films 6a and 6b. Both of the alignment control films 6a and 6b may preferably be subjected to a uniaxial alignment treatment (e.g., rubbing). Each of the alignment control film 6a (6b) may be prepared by forming a film of an organic material (such as polyimide, polyimideamide, polyamide or polyvinyl alcohol) through wet coating with a solvent, followed by drying and rubbing in a prescribed direction; by forming a deposited film of an inorganic material through an oblique vapor deposition such that an oxide (e.g., SiO) or a nitride is vapor-deposited onto a substrate in an oblique direction with a prescribed angle to the substrate; or by forming an optical alignment control film capable of possessing a uniaxial alignment control force by irradiation with ultraviolet rays, etc.

The alignment control films 6a and 6b may appropriately be controlled to provide liquid crystal molecules of the above-mentioned liquid crystal 2 disposed therebetween with a prescribed pretilt angle α (an angle formed between the liquid crystal molecule and the alignment control film surface at the boundaries with the alignment control films) by changing the material and treating conditions (of the uniaxial alignment treatment).

In the case of effecting the uniaxial alignment treatment (rubbing) of the alignment control films 6a and 6b, the respective uniaxial alignment treatment (rubbing) directions may appropriately be set in an anti-parallel relationship (wherein they are parallel to each other but directed oppositely), a parallel relationship (wherein they are parallel to each other and directed in the same direction) or a crossed relationship (wherein they intersect with each other at a crossing angle of at most 45 degrees.

In the crossed relationship, two vectors for the two directions may be located in the same direction or opposite to each other based on the position of vectors for the parallel and anti-parallel directions. In the present invention, when the two uniaxial alignment treatment directions of the alignment control films 6a and 6b intersect with each other at a crossing angle closer to zero degree, e.g., at most several degrees, a relationship thereof may be regarded as the parallel or anti-parallel relationship. The alignment control films 6a and 6b referred to herein may also include those which have been subjected to uniaxial alignment treatment if they can have some influence on an alignment state of the liquid crystal 2 directly contacting the alignment control films 6a and 6b.

The substrates 1a and 1b are disposed opposite to each other via a spacer (not shown) comprising e.g., silica beads for determining a distance (i.e., cell gap) therebetween, preferably in the range of 0.3-10 μm, in order to provide a uniform uniaxial alignment performance and such an alignment state that an average molecular axis of the liquid crystal molecules under no electric field application is substantially aligned with an average uniaxial aligning treatment axis (or a bisector of two uniaxial aligning treatment axes) although the cell gap varies its optimum range and its upper limit depending on the liquid crystal material used.

In addition to the spacer, it is also possible to disperse adhesive particles (not shown) of a resin (e.g., epoxy resin) between the substrates 1a and 1b in order to improve adhesiveness therebetween and an impact (shock) resistance of the chiral smectic liquid crystal device P.

In the present invention, the liquid crystal device P may be of a light-transmission type or a reflection type. In the light-transmission type liquid crystal device, the pair of substrates 1a and 1b may be formed of a transparent material. The liquid crystal device of the reflection-type may, e.g., be prepared by forming a reflection plate or film on either one of the substrates 1a and 1b or forming one of the substrates per se of a reflective material, thus imparting a light-reflection function to one of the substrates 1a and 1b.

In the case of the liquid crystal device of the transmission type, a pair of polarizers (not shown) are disposed outside the pair of substrates 1a and 1b so that their polarization axes are disposed perpendicular to each other (cross-nicol relation-ship). On the other hand, in the case of the liquid crystal device of the reflection type, at least one of the substrates 1a and 1b may be provided with a polarizer.

The liquid crystal device P may be used as a color liquid crystal device by providing one of the pair of substrates 1a and 1b with a color filter comprising color filter segments of, e.g., at least red (R), green (G) and blue (B) at respective pixels. It is also possible to effect a full-color display by successively switching (lighting) a light source comprising, e.g., R light source, G light source and B light source emitting different color light fluxes to effect color mixing while changing image data in synchronism with the light emission (field sequential scheme).

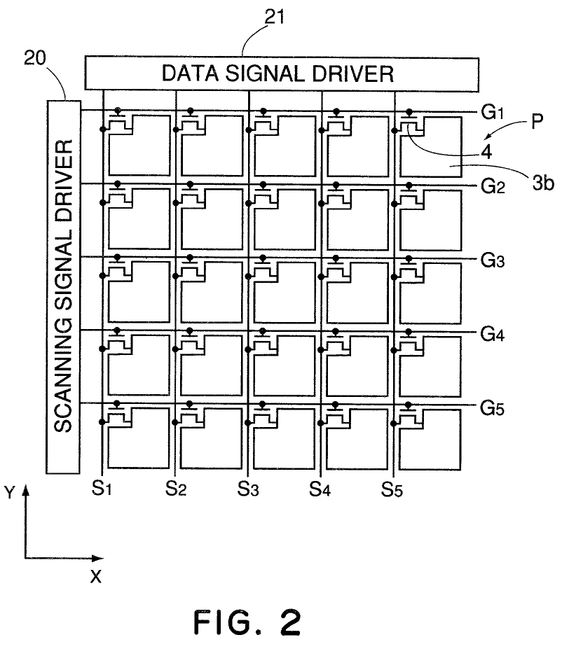

In the present invention, by using the above-mentioned liquid crystal device in combination with a drive circuit for supplying gradation signals to the liquid crystal device, it is possible to provide a liquid crystal display apparatus capable of effecting a gradational display based on the above-mentioned alignment characteristic such that under voltage application, a resultant tilting angle varies continuously from the monostabilized position of the average molecular axis (of liquid crystal molecules) and a corresponding emitting light quantity continuously changes, depending on the applied voltage. For example, it is possible to use, as one of the pair of substrates, an active matrix substrate provided with a plurality of switching elements (e.g., TFT (thin film transistor) or MIM (metal-insulator-metal)) in combination with a drive circuit (drive means) 21 as shown in FIG. 2, thus effecting an active matrix drive based on amplitude modulation to allow a gradational display in an analog gradation manner.

Hereinbelow, an embodiment of the active matrix-type liquid crystal device P produced by the process of the present invention will be explained with reference to FIGS. 1 and 2.

The liquid crystal device P shown in these figures includes a pair of glass substrates 1a and 1b disposed opposite to each other with a prescribed spacing therebetween.

On the entire surface of one of the glass substrates (1a in this embodiment), a common electrode 3a is formed in a uniform thickness and coated with an alignment control film 6a.

On the other glass substrate 1b, as shown in FIG. 2, scanning signal lines (gate lines) (G1, G2, G3, G4, G5, . . . ) which are arranged in an X direction and connected to a scanning signal driver 20 (drive means) and data signal lines (source lines) (S1, S2, S3, S4, S5, . . . ) which are arranged in a Y direction and connected to a data signal driver 21 (drive means) are disposed to intersect each other at right angles in an electrically isolated state, thus forming a matrix of pixels (5×5 in FIG. 2) each at intersection thereof. Each pixel is provided with a thin film transistor (TFT) 4 as a switching element and a pixel electrode 3b. The scanning signal (gate) lines (G1, G2, . . . ) are connected with gate electrodes 10 of the TFT 4, respectively, and the data signal (source) lines (S1, S2, . . . ) are connected with source electrodes 14 of the TFT 4, respectively. The pixel electrodes 3b are connected with drain electrodes 15 of the TFT 4, respectively.

In this embodiment, each pixel may be provided with an amorphous silicon (a-Si) TFT as the TFT 4. The TFT may be of a polycrystalline-Si (p-Si) type.

As shown in FIG. 1, the TFT 4 is formed on the glass substrate 1b includes: a gate electrode 10 connected with the gate lines (G1, G2, . . . shown in FIG. 2); an insulating film (gate insulating film) 5b of, e.g., silicon nitride (SiNx) formed on the gate electrode 10; an a-Si layer 11 formed on the insulating film 5b; n⁺ a-Si layers 12 and 13 formed on the a-Si layer 11 and spaced apart from each other; a source electrode 14 formed on the n⁺ a-Si layer 12; a drain electrode 15 formed on the n⁺ a-Si layer 13 and spaced apart from the source electrode 14; a channel protective film 16 partially covering the a-Si layer 11 and the source and drain electrodes 12 and 13. The source electrode 12 is connected with the source lines (S1, S2, . . . shown in FIG. 2) and the drain electrode 13 is connected with the pixel electrode 3b (FIG. 2) of a transparent conductor film (e.g., ITO film).

Further, on the glass substrate 1b, a structure constituting a holding or storage capacitor (Cs shown in FIG. 2) is formed by the pixel electrode 3b, a storage capacitor electrode 7 disposed on the substrate 1b, and a portion of the insulating film 5b sandwiched therebetween. The structure (storage capacitor) (Cs) is disposed in parallel with the liquid crystal layer 2. In the case where the storage capacitor electrode 7 has a large area, a resultant aperture or opening rate is decreased. In such a case, the storage capacitor electrode 7 is formed of a transparent conductor film (e.g., ITO film).

On the TFT 4 and the pixel electrode 3b of the glass substrate 1b, an alignment control film 6b is formed and subjected to uniaxial aligning treatment (e.g., rubbing).

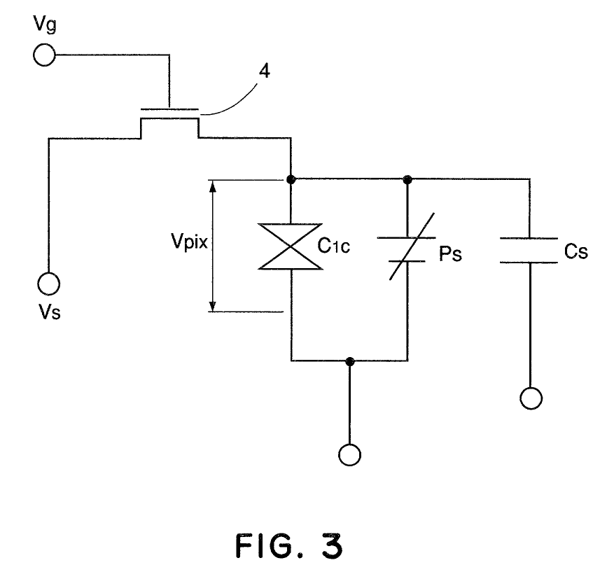

Between the pixel electrode 3b formed on the glass substrate 1b and the common electrode 3a formed on the glass substrate 1a, the chiral smectic liquid crystal 2 having a spontaneous polarization (Ps) is disposed to constitute a liquid crystal capacitor (C_{1c}) (FIG. 3).

The above liquid crystal device P shown in FIG. 1 is sandwiched between a pair of cross-nicol polarizers (not shown) (provided with polarizing axes disposed perpendicular to each other).

Next, an example of an ordinary active matrix driving method utilizing the active matrix-type liquid crystal device P will be described with reference to FIGS. 4 and 5 in combination with FIGS. 1 and 2.

In the above-mentioned liquid crystal device P1, a gate(-on) voltage is successively applied to each gate electrode (G1, G2, . . . ) from the scanning signal driver 20 in a line-sequential manner, whereby the TFT 4 is supplied with the gate voltage to be placed in an “ON” state.

In synchronism with the gate voltage application, source lines (S1, S2, . . . ) are supplied with a source voltage (a data signal voltage depending on writing information (data) for each pixel) from the data signal driver 21.

Accordingly, at a pixel where its TFT 4 is placed in an “ON” state, the source voltage is applied to the chiral smectic liquid crystal 2 via the TFT 4 and a corresponding pixel electrode 3b, thus allowing switching of the liquid crystal 2 for each pixel.

The above driving operation is repeated for a prescribed period (frame period) to effect re-writing of image.

In the case where such image re-writing operation is performed in each field period by dividing one frame period F0 into plural field periods (e.g., first and second field periods F1 and F2) as shown in FIG. 4, the following driving method may be applicable.

Referring to FIG. 4, at (a) is shown a waveform of gate voltage Vg applied to one gate line Gi; at (b) is shown a waveform of source voltage Vs applied to one source line Sj; at (c) is shown a waveform of voltage Vpix applied to the chiral smectic liquid crystal 2 at a pixel formed at an intersection of these gate and source line Gi an Sj; and at (d) is shown a change in transmitted light quantity T at the pixel. In this embodiment, the chiral smectic liquid crystal 2 used in the liquid crystal device P1 provides a V-T characteristic as shown in FIG. 5.

Referring again to FIG. 4, in one (first) field period (F1), one gate line Gi is supplied with a gate voltage Vg in a prescribed (selection) period Ton (as shown at (a)) and in synchronism with the gate voltage application, one source line Sj is supplied in the selection period Ton with a source voltage Vs (=V =+Vx) based on a potential Vc (reference potential) of a common electrode 3a (FIG. 1) (as shown at (b)) At this time, a TFT 4 at the pixel concerned is turned on by the application of gate voltage Vg and the source voltage Vx is applied to the liquid crystal 2 via the TFT 4 and a pixel electrode 3b, thus charging a liquid crystal capacitor Clc and a storage capacitor Cs.

In a non-selection period Toff other than the selection period Ton in the field period F1, the gate voltage Vg is applied to gate lines G1, G2, . . . , other than the gate line Gi. As a result, the gate line Gi is not supplied with the gate voltage Vg in the non-selection period Toff, whereby the TFT 4 is turned off. Accordingly, the liquid crystal capacitor C1c and storage capacitor Cs hold the electric charges charged therein, respectively, to provide the voltage Vx (=Vpix) through the field period F1 (as shown at (c)). The liquid crystal 2 supplied with the voltage Vx through the field period F1 provides a transmitted light quantity Tx substantially constant in the sub-field period F1 (as shown at (d)).

In the case where the response time of the liquid crystal is larger than the selection period Ton, the charging of the liquid crystal capacitor (C1c) and the storage capacitor (Cs) and a switching of the liquid crystal 2 are effected in the non-selection period Toff. In this case, the electrical charges stored in the capacitors are reduced due to inversion of spontaneous polarization to provide a driving (pixel) voltage Vpix smaller than the voltage +Vx by a voltage Vd applied to the liquid crystal layer 2 as shown at (c) of FIG. 4.

In the subsequent (second) field period F2, the above-described gate line Gi is again supplied with the gate voltage Vg (in Ton) (as shown at (a)) and in synchronism therewith, the source line Sj is supplied with a source voltage −Vs (=−Vx) (of a polarity opposite to that of the source voltage +Vx in F1) (as shown at (b)), whereby the source voltage −Vx is charged in the liquid crystal capacitor C1c and holding capacitor Cs in Ton and kept in Toff (as shown at (c)), thus retaining a transmitted light quantity Ty substantially constant in the field period F2 (as shown at (d)).

In the case where the response time of the liquid crystal is larger than the selection period Ton, the charging of the liquid crystal capacitor (C1c) and the storage capacitor (Cs) and a switching of the liquid crystal are effected in the non-selection period Toff. In this case, similarly as in the preceding field period F1, the electrical charges stored in the capacitors are reduced due to inversion of spontaneous polarization to provide a driving (pixel) voltage Vpix smaller than the voltage −Vx by a voltage Vd (as an absolute value) applied to the liquid crystal layer 2 as shown at (c) of FIG. 4.

In the above driving method shown in FIG. 4, switching of the chiral smectic liquid crystal 2 is performed for each field period (F1 or F2) depending on magnitude of an applied driving voltage to display gradational states (levels) (transmitted light quantities Tx and Ty) different between the field periods F1 and F2. As a result, in the entire frame period F0, the resultant transmitted light quantity becomes an average of Tx and Ty.

The transmitted light quantity Ty in the second field period F2 is considerably smaller than Tx (in the first field period F1) and closer to zero, whereby the resultant transmitted light quantity in the entire frame period F0 (F1+F2) is also lowered compared with Tx in the first field period F1. For this reason, in an actual drive of the liquid crystal device P1, based on an objective transmitted light quantity (gradational level of display image) through the entire frame period F0, a driving voltage Vx (−Vx) may preferably be determined appropriately by setting a transmitted light quantity Tx in the first field period F1 to be higher on than the objective transmitted light quantity.

In the above-mentioned driving method, a positive-polarity driving voltage (+Vx) is applied to the liquid crystal 2 in each odd-numbered field period (e.g., F1 shown in FIG. 4) and a negative-polarity driving voltage (−Vx) is applied to the liquid crystal 2 in each even-numbered field period (e.g., F2), whereby an overall driving voltage actually applied to the liquid crystal 2 is alternately changed (periodically) in polarity with time, thus effectively preventing deterioration of the liquid crystal 2.

Further, a higher luminance display is performed in the first field period F1 and a lower luminance display is performed in the second field period F2, thus resulting in a time-integrated aperture (opening) rate of at most ca. 50%. As a result, when motion pictures are displayed by using such a liquid crystal device P1, resultant image qualities become good.

The chiral smectic liquid crystal 2 used in the present invention shows a phase transition series on temperature decrease of Iso−Ch−SmC* or Iso−SmC* as described above, thus lacking smectic A phase (SmA) which is generally confirmed in ordinary chiral smectic liquid crystal materials.

In the present invention, when a chiral smectic liquid crystal 2 having a phase transition series of Iso−Ch−SmC* is subjected to strict observation through a polarizing microscope with respect to its phase transition from Ch or SmC*, an alignment state closer to that in SmA is observed in some cases. However, such a chiral smectic liquid crystal shows an alignment state in SmC* such that a direction of a normal to smectic molecular layers is largely different from a direction of uniaxial alignment treatment (rubbing) and liquid crystal molecules are monostabilized at a position closer to the rubbing direction under no electric application, thus being not affected by the alignment state closer to that in SmA described above. For this reason, the chiral smectic liquid crystal showing a liquid crystal phase closer to SmA during the phase transition from Ch to SmC* as described above may be inclusively used as the chiral smectic liquid crystal 2 in the present invention (assuming no SmA phase).

In the case where the aging treatment is performed in the driving method for the liquid crystal device according to the present invention, similarly as in the above-mentioned driving method, the gate voltage is applied from the scanning signal driver 20 to the respective gate lines (G1, G2, . . . ), and in synchronism therewith, the aging voltage is applied from the data signal driver 21 to the source lines (S1, S2, . . . ).

As described above, in the case where the polarity of aging voltage is alternately changed when the active elements are periodically turned on, inversion of a spontaneous polarization of liquid crystal molecules is caused to occur every on-time of the active elements, thus leading to a lowering in aging voltage (Vd as shown at (c) of FIG. 4).

However, in the present invention, as shown at (c) of FIG. 7, the prescribed-polarity voltage (+Vx) is periodically applied in at least two consecutive field periods (F1 and F2), whereby the lowering in aging voltage (Vd) can effectively be suppressed (as shown in F2 at (c) of FIG. 7), thus enhancing the effect of aging treatment while reducing a time required therefor.

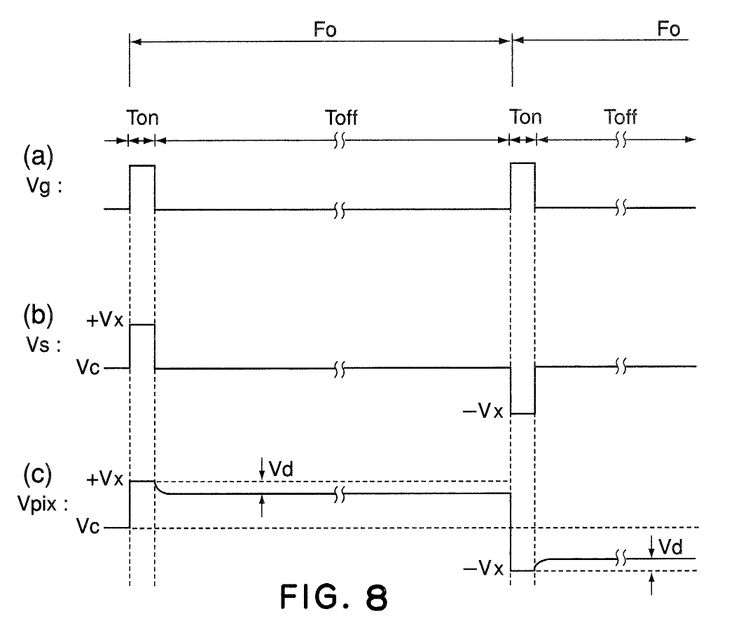

When an aging voltage of one polarity is applied only in a longer period (frame period F0 shown in FIG. 8), as shown at (c) of FIG. 8, the voltage lowering (Vd) described above is continued over the frame period F0, thus resulting in a lower voltage (as a time-integrated value) applied to the liquid crystal 2. On the other hand, in the aging treatment used in the present invention as shown at (c) of FIG. 7, the aging voltage (+Vx) in the second field period F2 of a polarity identical to that (+Vx) in the first field period F1 is applied again to the liquid crystal 2, thus effectively suppressing the lowering in voltage (Vd) as shown in F2 at (c) of FIG. 7 while reducing a time for the aging treatment.

Hereinbelow, the lowering in voltage applied to the liquid crystal 2 is further explained.

When the respective gate lines (G1, G2, . . . ) ar sequentially scanned (selected), the resultant gate voltage application period becomes shorter. For this reason, in the present invention, in order to prolong the gate voltage application period, a plurality or all of the gate lines are scanned at the same time in a line-sequential manner, or a frame frequency (rate) is decreased thereby to prolong one frame period per se. Alternatively, it is possible to adopt the above-mentioned scanning scheme and the decrease in frame frequency simultaneously.

Generally, in the case where the aging treatment is effected to an active matrix-type liquid crystal device, (chiral smectic) liquid crystal molecules are inverted during a period wherein active elements 4 are turned on to be supplied with (electric) charges and retains the inverted state by the charges held in a liquid crystal capacitor C1c even after the active elements 4 are turned off.

However, the changes held in the liquid crystal capacitor C1c is decreased by the inversion of liquid crystal molecules after the active elements 4 are turned off. Accordingly, a total amount of the aging voltage applied to the liquid crystal 2 (i.e., a time-integrated value (=∫Vdt) of the aging voltage from a time of turning on the active elements 4 to a time of completion of the liquid crystal inversion after the active elements 4 are turned off) becomes smaller with an increasing amount of the liquid crystal inversion after the active elements 4 are turned off. When such a total amount of the aging voltage is decreased, the resultant V-T characteristic is not completely stabilized by effecting the aging treatment one time.

In the aging treatment employed in the present invention, however, the aging voltage is applied in the above-described manner (such that the polarity thereof is identical over at least two consecutive conditioning periods (e.g., field periods), whereby it is possible to prevent a lowering in charges held in the liquid crystal capacitor and a lowering in the total amount of aging voltage, thus effectively performing the aging treatment.

The V-T characteristic of the liquid crystal 2 stabilized by the aging treatment as described above is not changed even when a voltage for displaying a prescribed image is applied to the liquid crystal 2, thus effectively suppressing an occurrence of burning or sticking phenomenon of displayed image.

Hereinbelow, the present invention will be described more specifically based on Examples.

### EXAMPLE 1

A chiral smectic liquid crystal composition LC-1 was prepared by mixing the following compounds in the indicated proportions.

| Structural formula | wt. % |
|---|---|
| 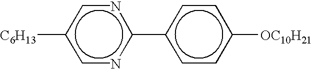 | 11.55 |
| 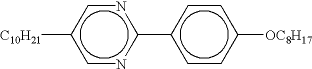 | 11.55 |
| 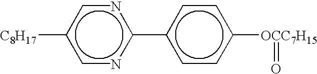 | 7.70 |
| 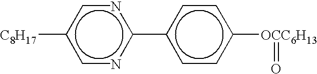 | 7.70 |
| 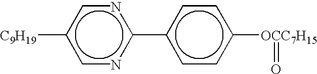 | 7.70 |
| 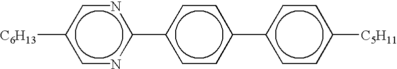 | 9.90 |
| 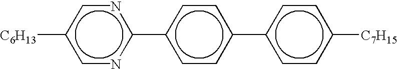 | 9.90 |
| 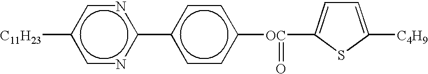 | 30.0 |
| 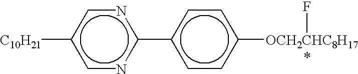 | 4.00 |

The thus-prepared liquid crystal composition LC-1 showed the following phase transition series and physical properties.

Phase Transition Temperature (°C)

$$Iso {\to }^{ 86.3 } Ch {\to }^{ 61.2 } {SmC}^{*} {\to }^{ - 7.2 } Cry$$

(Iso: isotropic phase, Ch: cholesteric phase, SmC*: chiral smectic C phase, Cry: crystal phase) Spontaneous polarization (Ps): 2.9 nC/cm² (30° C.) Tilt angle \mathring{H}: 23.3 degrees (30° C.), AC voltage =100 Hz and ±12.5 V, cell gap =1.4 μm) Helical pitch (SmC*): at least 20 μm (30° C.)

The values of spontaneous polarization Ps, tilt angle \mathring{H}, and layer inclination angle δ in smectic layer referred to herein are based on values measured according to the following methods.

Measurement of Spontaneous Polarization Ps

The spontaneous polarization Ps was measured according to “Direct Method with Triangular Waves for Measuring Spontaneous Polarization in Ferroelectric Liquid Crystal”, as described by K. Miyasato et al (Japanese J. Appl. Phys. 22, No. 10, pp. L661-(1983)).

Measurement of Tilt Angle \mathring{H}

A liquid crystal device was sandwiched between right angle-cross nicol polarizers and rotated horizontally relative to the polarizers under application of an AC voltage of ±12.5 V to ±50 V and 1 to 100 Hz between the upper and lower substrates of the device while measuring a transmittance through the device by a photomultiplier (available from Hamamatsu Photonics K.K.) to find a first extinct position (a position providing the lowest transmittance) and a second extinct position. A tilt angle \mathring{H} was measured as half of the angle between the first and second extinct positions.

A blank cell was prepared in the following manner.

A pair of 1.1 mm-thick glass substrates each provided with a 700 Å-thick transparent electrode of ITO film was provided except that one of the pair of glass substrate was formed in an active matrix substrate provided with a plurality of a-Si TFTs and a silicone nitride (gate insulating) film and the other glass substrate (counter substrate) was provided with a color filter including color filter segments of red (R), green (G) and blue (B).

The thus prepared blank cell (active matrix cell) having a structure had a picture area size of 10.4 inches including a multiplicity of pixels (800 (×RGB)×600).

On each of the transparent electrodes (of the pair of glass substrates), a polyimide precursor (“SE7992”, mfd. by Nissan Kagaku K. K.) was applied by spin coating and pre-dried at 80° C. for 5 min., followed by hot-baking at 200° C. for 1 hour to obtain a 150 Å-thick polyimide film.

Each of the thus-obtained polyimide film was subjected to rubbing treatment (as a uniaxial aligning treatment) with a cotton cloth under the following conditions to provide an alignment control film.

Rubbing roller: a 10 cm-dia. roller about which a cotton cloth was wound.

Pressing depth: 0.7 mm

Substrate feed rate: 10 cm/sec

Rotation speed: 1000 rpm

Substrate feed: 4 times

Then, on one of the substrates, silica beads (average particle size=1.5 μm) were dispersed and the pair of substrates were applied to each other so that the rubbing treating axes were in parallel with each other but oppositely directed (anti-parallel relationship), thus preparing a blank cell with a uniform cell gap.

The liquid crystal composition LC-1 was injected into the above-prepared blank cell in its cholesteric phase state and gradually cooled to a temperature providing chiral smectic C phase to prepare a liquid crystal device (panel) P.

In the above cooling step from Iso to SmC*, the device was subjected to a DC voltage application treatment such that a DC (offset) voltage of −2 volts was applied in a temperature range of Tc ±2° C. (Tc: Ch−SmC* phase transition temperature) while cooling the device at a rate of 1° C./min.

The thus-prepared liquid crystal device P was subjected to the aging treatment in the following manner.

One frame period F0 (=(1/60) sec) is divided into first to fourth field periods F1 to F4 (=1/240) sec). In the first and second field periods F1 and F2, a positive source voltage (aging voltage) (Vs=+Vx) of +5 V was applied. In the third and fourth field periods F3 and F4, a negative source voltage (aging voltage) (Vs=−Vx) of −5 V was applied to effect the aging treatment.

In the above-mentioned manner, 10 liquid crystal devices (panels) P1 to P10 were prepared by setting aging period (Taging) of 1 min., 2 min., 3 min., 4 min., 5 min., 10 min., 15 min., 20 min., 25 min., and 30 min., respectively.

These liquid crystal devices P1 to P10 were driven by applying a driving waveform including a source voltage of 3 V (for displaying an intermediate (halftone) image) as shown in FIG. 4 to measure a transmittance by using an oscilloscope. In this case, the transmittance was determined based on a luminance of the liquid crystal devices. Specifically, the luminance when the liquid crystal device was sandwiched between a pair of cross-nicol polarizers and heated to an isotropic phase temperature was taken as a transmittance of 100%.

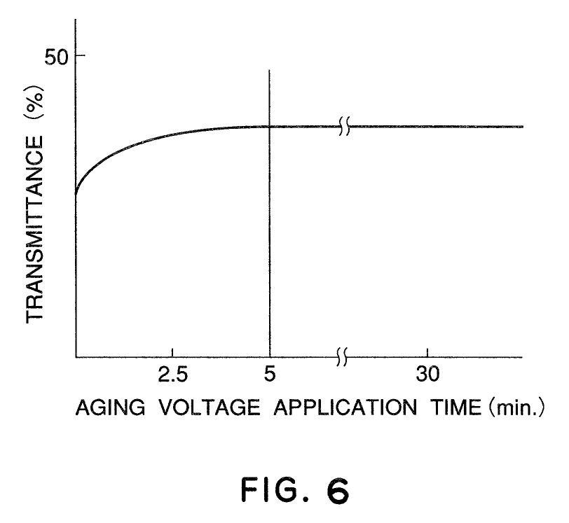

The results are shown in FIG. 6.

As shown in FIG. 6, the V-T characteristic was stabilized by the aging treatment for about 5 min.

Referring to FIG. 6, the abscissa represents an application time of the aging voltage (5 V) (i.e., the aging period for aging treatment), not for the driving voltage for image display (3 V), and the ordinate represents a transmittance at the time of applying the driving voltage for image display of 3 V.

The transmittance when the liquid crystal device was driven by using the driving waveform shown in FIG. 4 was different between the first field period F1 (Tx) and the second field period (Ty). Accordingly, the ordinate value (transmittance) of FIG. 6 was an average of a time-integrated value of transmittance given by the following equation:

$${\int }_{τ}^{τ + ( F1 + F2 )} T ⅆ t / ( F1 + F2 ) ,$$

wherein τ represents a prescribed time, T represents a transmittance (%), and t represents a time.

In this example, the voltage for image display was set to 3V and different from that for aging treatment of 5 V. This is because the change in V-T characteristic is readily observed as a difference in transmittance due to a difference in aging voltage application time (aging period).

For comparison, an aging treatment was performed by alternately changing a polarity of aging voltage for each field period as shown in FIG. 4.

Specifically, one frame period F1 (=1/60) sec) is divided into a first field period F1 (=(1/120) sec) and a second field period F2 (=(1/120) sec) In the first field period F1, a positive source voltage (aging voltage) (Vs=+Vx) of +5 V was applied, and in the second field period F2, a negative source voltage (aging voltage) (Vs=−Vx) of −5 V was applied to effect the aging treatment.

As a result, in order to stabilize the V-T characteristic of the liquid crystal, it was necessary to effect the aging treatment for about 10 min.

Accordingly, it was found that the time for the aging treatment (FIG. 4) was reduced to the half thereof by the aging treatment used in this example.

As a result, the aging treatment according to this example was found to be effective for reducing the aging voltage application time.

Further, when the liquid crystal devices subjected to the aging treatment for at least 5 min. (according to the manner of this example) were subjected to halftone image display (transmittance of 50%) after effecting continuous image display of a white and black chart pattern for ca. 5 hours, no image burning phenomenon was observed. This may be attributable to a completely stabilized V-T characteristic by the aging treatment, thus causing no change in V-T characteristic thereby to improve a reliability against the image burning.

### EXAMPLE 2

A liquid crystal device was prepared and subjected to aging treatment in the same manner as in Example 1 except that, as shown in FIG. 7, each frame period F0 (=(1/60) sec) was divided into two field periods F1 (=(1/120) sec) and F2 (=(1/120) sec) and, a positive source voltage (aging voltage) (Vs=+Vx) of +5 V was applied for respective even-numbered frames and a negative source voltage (aging voltage) (Vs=−Vx) of −5 V was applied for respective odd-numbered frames.

As a result, it was found that the aging treatment was completed in about 5 min.

As described hereinabove, according to the present invention, the polarity of aging voltage is set to be identical over at least two consecutive field periods for each on-time of the active elements, thus effectively preventing a lowering in voltage (as a time-integrated value) applied to the chiral smectic liquid crystal due to inversion of spontaneous polarization of liquid crystal molecules. As a result, the aging treatment can be effectively performed in a short period of time while stabilizing the V-T characteristic of the liquid crystal.

What is claimed is:

1. A process for producing a liquid crystal device of the type comprising: a pair of substrates, a chiral smectic liquid crystal disposed between the substrates so as to form a matrix of pixels arranged in a plurality of rows and a plurality of columns, a plurality of active elements each provided to a pixel for supplying a voltage applied to the liquid crystal at the pixel, and an electrode matrix including drive signal supply electrodes for applying drive signal voltages to the respective active elements which will be turned on by periodically applying the data signal voltages to associated pixels in a succession of display frame periods;
the process, comprising the step of:
periodically turning on the active elements by periodically applying conditioning voltages to associated pixels in a succession of conditioning periods, preceding the display frame periods, in which the periodically applied conditioning voltages have an identical polarity over at least two consecutive conditioning periods, so as to stabilize a voltage-transmittance of the liquid crystal.

2. A process according to claim 1, wherein the polarity of conditioning voltages in said at least two consecutive conditioning periods is changed to a polarity opposite thereto in at least one conditioning period subsequent to the consecutive conditioning periods.

3. A process according to claim 1, wherein the chiral smectic liquid crystal shows a phase transition series of isotropic phase (Iso), cholesteric phase (Ch) and chiral smectic C phase (SmC*) or a phase transition series of isotropic phase (Iso) and chiral smectic C phase (SmC*), respectively, on temperature decrease.

4. A process according to claim 1, wherein the supply of conditioning voltage is performed in a state that the chiral smectic liquid crystal assumes chiral smectic C phase.

5. A process according to claim 1, wherein the supply conditioning voltage is performed to substantially all the pixels.

6. A driving method for a liquid crystal device of the type comprising: a pair of substrates, a chiral smectic liquid crystal disposed between the substrates so as to form a matrix of pixels arranged in a plurality of rows and a plurality of columns, a plurality of active elements each provided to a pixel for supplying a voltage applied to the liquid crystal at the pixel, and an electrode matrix including drive signal supply electrodes for applying drive signal voltages to the respective active elements;
the driving method, comprising the steps of:
periodically turning on by periodically applying the data signal voltages to associated pixels in a succession of display frame periods; and
periodically turning on the active elements by periodically applying conditioning voltages to associated pixels in a succession of conditioning periods, preceding the display frame periods, in which the periodically applied conditioning voltages have an identical polarity over at least two consecutive conditioning periods, so as to stabilize a voltage-transmittance of the liquid crystal.

7. A process according to claim 6, wherein the polarity of conditioning voltages in said at least two consecutive conditioning periods is changed to a polarity opposite thereto in at least one conditioning period subsequent to the consecutive conditioning periods.

8. A method according to claim 6, wherein the chiral smectic liquid crystal shows a phase transition series of isotropic phase (Iso), cholesteric phase (Ch) and chiral smectic C phase (SmC*) or a phase transition series of isotropic phase (Iso) and chiral smectic C phase (SmC*), respectively, on temperature decrease.

9. A method according to claim 6, wherein the supply of conditioning voltage is performed in a state that the chiral smectic liquid crystal assumes chiral smectic C phase.

10. A method according to claim 6, wherein the supply conditioning voltage is performed to substantially all the pixels.

11. A method according to claim 6, wherein the supply of conditioning voltage is automatically performed after a power for actuating the liquid crystal device is turned on.

12. A method according to claim 6, wherein the supply of conditioning voltage is automatically performed at the time of actuating a screen saver for the liquid crystal device.

13. A method according to claim 6, wherein the supply of conditioning voltage is performed in a state wherein the liquid crystal device is not illuminated with light.
